(19) United States
(12) Patent Application Publication
(10) Pub. No.: US 2016/0089962 A1
(43) Pub. Date: Mar. 31, 2016

(54) GLASS RUN FOR MOTOR VEHICLE

(71) Applicant: TOYODA GOSEI CO., LTD., Kiyosu-shi (JP)

(72) Inventor: Mikiya KUROKI, Kiyosu-shi (JP)

(21) Appl. No.: 14/860,966

(22) Filed: Sep. 22, 2015

(30) Foreign Application Priority Data
Sep. 26, 2014 (JP) 2014-196337

(51) Int. Cl. B60J 1/00; E06B 3/44; B60J 10/00; B60J 5/04

(52) U.S. Cl. CPC B60J 1/007; B60J 5/0468; E06B 3/44; B60J 10/0054; B60J 10/0068

(57) ABSTRACT

A glass run includes: a bottom wall; an outboard side wall; an inboard side wall; an outboard cover lip; and an inboard cover lip, wherein: a flange portion at a distal end of a door outer panel of the door frame is held in an outboard holding channel formed between the outboard side wall and the outboard cover lip; a flange portion at a distal end of a door inner panel of the door frame is held in an inboard holding channel formed between the inboard side wall and the inboard cover lip; the bottom wall is held by a door reinforcement panel of the door frame; an outboard holding projecting portion is formed from the outboard side wall in the direction of the outboard holding channel; and one end of the outboard holding projecting portion is brought into abutment with the outer panel.

### CROSS-REFERENCE TO RELATED APPLICATION(S)

This application is based upon and claims the benefit of priority from Japanese Patent Application No. 2014-196337, filed on Sep. 26, 2014, the entire contents of which are incorporated herein by reference.

### BACKGROUND

1. Field of the Invention

The present invention relates to a glass run for a motor vehicle, which is attached to a door frame of a front side door of the motor vehicle to guide a vertical movement of a glass window.

2. Description of the Related Art

As shown in FIG. 3, a glass run 110 is attached to an inner circumference of a door frame 2 of a front side door 1 of a motor vehicle to guide a vertical movement of a glass window 5. Conventionally, as shown in FIG. 3, the glass run 110 is mounted in a channel 103 of the door frame 2 not only to guide the vertical movement of the glass window 5 but also to constitute a seal between the glass window 5 and the door frame 2.

Further, as shown in FIG. 2, the glass run 110 includes straight portions 111 which are formed through extrusion and glass run corner portions 112 which are molded to have shapes matching corner portions 2h of the door frame 2. The straight portions 111 are made up of a glass run upper side portion 113 which is attached to an upper side portion 2b of the door frame 2, a glass run front vertical side portion 114 which is attached to a front vertical side portion 2a of the door frame 2, and a glass run rear vertical side portion 115 which is attached to a rear vertical portion 2a of the door frame 2.

Sealing between the front side door 1 and a body is executed by door weatherstrips (not shown) which are attached to outer circumferences of a door panel and the door frame 2 and/or an opening trim weatherstrip (not show) which is attached to a flange of an opening portion in the body.

As shown in FIG. 4, the glass run 110 has a substantially U-shaped cross section which is defined by an outboard side wall 120, an inboard side wall 130 and a bottom wall 140. An outboard seal lip 121 is provided on the outboard side wall 120 so as to extend from a distal end portion thereof towards an inside of a main body of the glass run 110 which has a substantially U-shaped cross section. Additionally, an inboard seal lip 131 is provided on the inboard side wall 130 so as to extend from a distal end portion thereof towards the inside of the substantially U-shaped cross section. Further, an outboard cover lip 123 is formed so as to extend from the distal end portion of the outboard side wall 120 in parallel to an external surface of the outboard side wall 120, and an inboard cover lip 133 is formed so as to extend from the distal end portion of the inboard side wall 130 in parallel to an external surface of the inboard side wall 130.

The outboard side wall 120, the inboard side wall 130 and the bottom wall 140 of the main body of the glass run 110 are fitted on flange portions of a door outer panel 2c and a door inner panel 2d of the door frame 2 (for example, refer to JP-A-2014-65373).

As this occurs, the flange portion of the door outer panel 2c is inserted between the outboard side wall 120 and the outboard cover lip 123. The bottom wall 140 is held by a flat surface portion of a door reinforcement panel 2e. A flange portion of the door reinforcement panel 2e and the flange portion of the door inner panel 2d are inserted between the inboard side wall 130 and the inboard cover lip 133.

When the glass window 5 is raised, a distal end of the glass window 5 is brought into abutment with the outboard seal lip 121, and the outboard seal lip 121 is pulled in together with the glass window 5 in a direction indicated by an arrow A in FIG. 4, a root of the outboard side wall 120 deflects in a direction indicated by an arrow B in FIG. 4 to thereby be caused to slide in between the door outer panel 2c and the door reinforcement panel 2e. Additionally, a distal end portion of the outboard cover lip 123 deflects in a direction indicated by an arrow C in FIG. 4. This produces a gap between the outboard cover lip 123 and the door outer panel 2c, whereby the distal end portion of the outboard cover lip 123 is caused to move away from the door outer panel 2c to produce a gap, leading to a problem that the external appearance is deteriorated.

### SUMMARY

An object of the invention is to provide a glass run in which no gap is produced between a cover lip and a door panel even though a glass window is raised or lowered.

According to a first aspect of the invention, there is provided a glass run for a motor vehicle, which is attached to an inner circumference of a door frame of a motor vehicle door to guide a vertical movement of a glass window, including: a glass run main body, having a substantially U-shaped cross section, including a bottom wall, an outboard side wall which extends from an outboard side edge portion of the bottom wall and an inboard side wall which extends from an inboard side edge portion of the bottom wall; an outboard seal lip and an inboard seal lip, which extend towards an inside of the substantially U-shaped cross section of the main body, provided on the outboard side wall and the inboard side wall, respectively, to seal an outboard surface and an inboard surface of the glass window by the outboard seal lip and the inboard seal lip, respectively; an outboard cover lip formed from a distal end of the outboard side wall so as to face an external surface of the substantially U-shaped cross section; and an inboard cover lip formed from a distal end of the inboard side wall so as to face an external surface of the substantially U-shaped cross section, wherein: a flange portion at a distal end of a door outer panel of the door frame is held in an outboard holding channel formed between the outboard side wall and the outboard cover lip; a flange portion at a distal end of a door inner panel of the door frame is held in an inboard holding channel formed between the inboard side wall and the inboard cover lip; the bottom wall is held by a door reinforcement panel of the door frame; an outboard holding projecting portion, whose rigidity is greater than those of other portions of the outboard side wall, is formed from the outboard side wall in the direction of the outboard holding channel; and one end of the outboard holding projecting portion is brought into abutment with the outer panel.

According to the first aspect of the invention, the glass run includes the glass run main body having the substantially U-shaped cross section formed by the bottom wall, the outboard side wall which extends from the outboard side edge portion of the bottom wall and the inboard side wall which extends from the inboard side edge portion of the bottom wall. Because of this, when the door is closed, the distal end of the glass window can be accommodated inside the main body of the glass run having the substantially U-shaped cross section which is formed by the outboard side wall, the inboard side wall and the bottom wall in the door frame, so that the glass window can be held in an ensured fashion while the glass window is being raised or lowered. When referred to herein, onboard and inboard denote an outside and an inside of a passenger compartment of the vehicle, respectively, with the door closed.

The outboard seal lip and an inboard seal lip, which extend towards the inside of the substantially U-shaped cross section of the main body, are provided on the outboard side wall and the inboard side wall, respectively, to seal the outboard surface and the inboard surface of the glass window by the outboard seal lip and the inboard seal lip, respectively. Because of this, when the glass window is raised or lowered, the outboard seal lip and the inboard seal lip are brought into abutment with the glass window at an upper side portion, whereby sealing between the door frame and the glass window is executed by the outboard seal lip and the inboard seal lip.

The outboard cover lip is formed from the distal end of the outboard side wall so as to face the external surface of the substantially U-shaped cross section, and the inboard cover lip is formed from the distal end of the inboard side wall so as to face the external surface of the substantially U-shaped cross section. Because of this, the flange portion of the door outer panel can be covered with the outboard cover lip, and the flange portion of the door inner panel can be covered with the inboard cover lip, whereby the flange portions can be covered with the cover lips, providing a good external appearance.

The flange portion at the distal end of the door outer panel of the door frame is held in the outboard holding channel formed between the outboard side wall and the outboard cover lip, and the flange portion at the distal end of the door inner panel of the door frame is held in the inboard holding channel formed between the inboard side wall and the inboard cover lip, and the bottom wall is held by the door reinforcement panel of the door frame. Because of this, the flange portion of the door outer panel can be held by the outboard holding channel, and the flange portion of the door inner panel can be held by the inboard holding channel, and the bottom wall can be held by the door reinforcement panel of the door frame, whereby the glass run can be held on the flange in an ensured fashion.

The outboard holding projecting portion whose rigidity is greater than those of the other portions of the outboard side wall is formed from the outboard side wall in the direction of the outboard holding channel, and the one end of the outboard holding projecting portion is brought into abutment with the door outer panel. Because of this, the outboard side wall is prevented from being caused to slide in between the door outer panel and the door reinforcement panel in raising or lowering of the glass window, which prevents, in turn, the distal end of the outboard cover lip from moving away from the door outer panel of the door frame.

According to a second aspect of the invention, the glass run is such that an outboard auxiliary projecting portion is formed in the direction of the outboard holding channel on the outboard side wall in a position lying closer to an opening side of the glass run main body than a portion where the outboard holding projecting portion is formed.

According to the second aspect of the invention, since the outboard auxiliary projecting portion is formed on the outboard side wall in the position lying closer to the opening side of the glass run main body than the portion where the outboard holding projecting portion is formed in the direction of the outboard holding channel, when the glass window enters the glass run main body portion to be raised or lowered with the outboard seal lip brought into abutment with the outboard side wall, the deformation of the outboard side wall is prevented, whereby the outboard cover lip can be prevented from moving away from the door outer panel.

According to a third aspect of the invention, the glass run is such that the outboard holding projecting portion of the outboard side wall is formed on a glass run vertical side portion which is mounted on a vertical side portion of the door frame.

According to the third aspect of the invention, since the outboard holding projecting portion of the outboard side wall is formed on the glass run vertical side portion which is mounted on the vertical side portion of the door frame, when the glass window enters the glass run main body portion to be raised or lowered with the outboard side wall deformed, the outboard side wall can particularly be prevented from being caused to slide in between the door outer panel and the door reinforcement panel at the vertical side portion where the outboard side wall would otherwise be caused to so slide in greatly.

According to a fourth aspect of the invention, the glass run is such that the outboard holding projecting portion whose rigidity is greater than those of the other portions of the outboard side wall is formed thicker than the other portions of the outboard side wall.

According to the fourth aspect of the invention, since the outboard holding projecting portion whose rigidity is greater than those of the other portions of the outboard side wall is formed thicker than the other portions of the outboard side wall, the forming of the outboard holding projecting portion becomes easy, which enhances the productivity of the glass run.

According to a fifth aspect of the invention, the glass run is such that the door outer panel is held by the outboard holding projecting portion whose rigidity is greater than those of the other portions of the outboard side wall and the outboard cover lip.

According to the fifth aspect of the invention, since the door outer panel is held by the outboard holding projecting portion whose rigidity is greater than those of the other portions of the outboard side wall and the outboard cover lip, the door outer panel can be held strongly and rigidly, whereby the glass run can be attached to the door frame strongly and rigidly.

Since the outboard holding projecting portion whose rigidity is greater than those of the other portions of the outboard side wall is formed from the outboard side wall in the direction of the outboard holding channel and the one end of the outboard holding projecting portion is brought into abutment with the door outer panel, the outboard side wall is prevented from being caused to slide in between the door outer panel and the door reinforcement panel in raising or lowering of the glass window, which prevents, in turn, the distal end of the outboard cover lip from moving away from the door outer panel of the door frame.

### BRIEF DESCRIPTION OF THE DRAWINGS

The present invention will become more fully understood from the detailed description given hereinbelow and the accompanying drawing which is given by way of illustration only, and thus is not limitative of the present invention and wherein:

FIG. 1 is a sectional view of a glass run according to an embodiment of the invention, showing a state in which the glass run is mounted on a vertical side portion of a door frame;

FIG. 2 is a front view of the glass run of the embodiment of the invention, FIG. 1 being the sectional view taken along a line A-A in FIG. 2;

FIG. 3 is a front view of a motor vehicle front side door; and

FIG. 4 is a sectional view of a conventional glass run which is mounted on a vertical side portion.

### DETAILED DESCRIPTION OF THE INVENTION

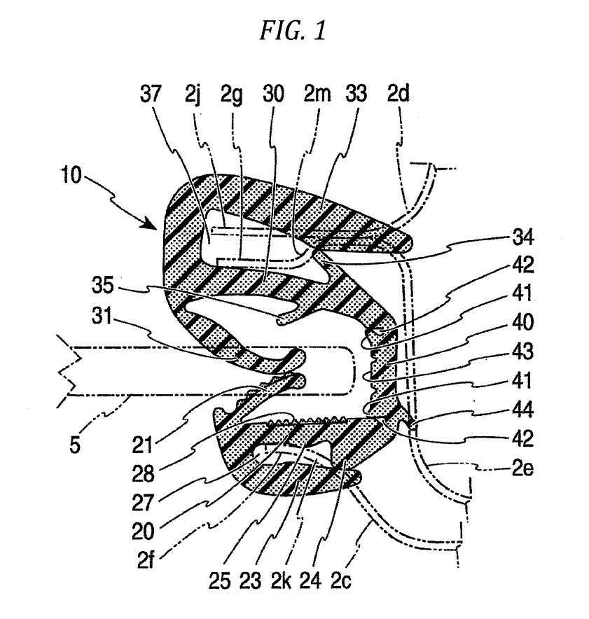

An embodiment of the invention will be described based on FIGS. 1 to 3.

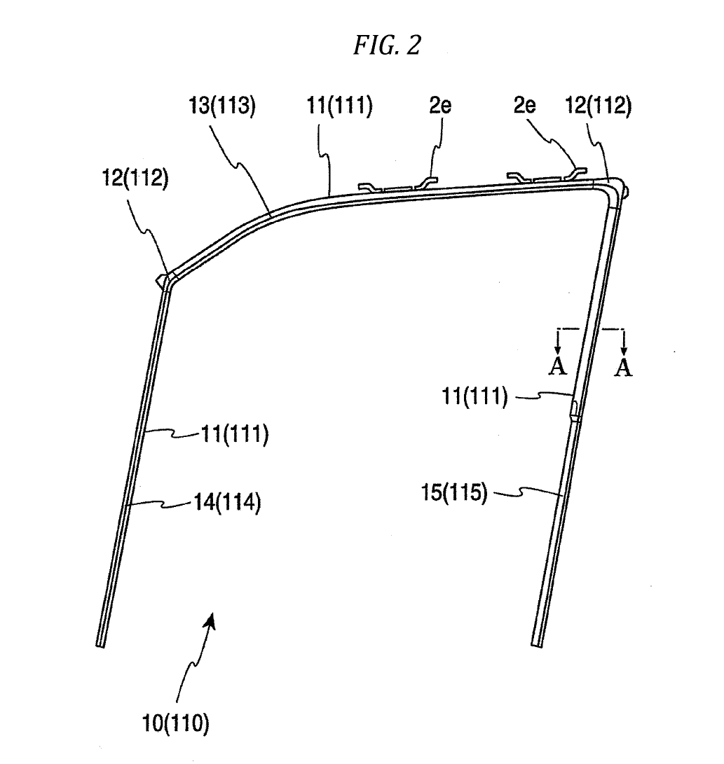

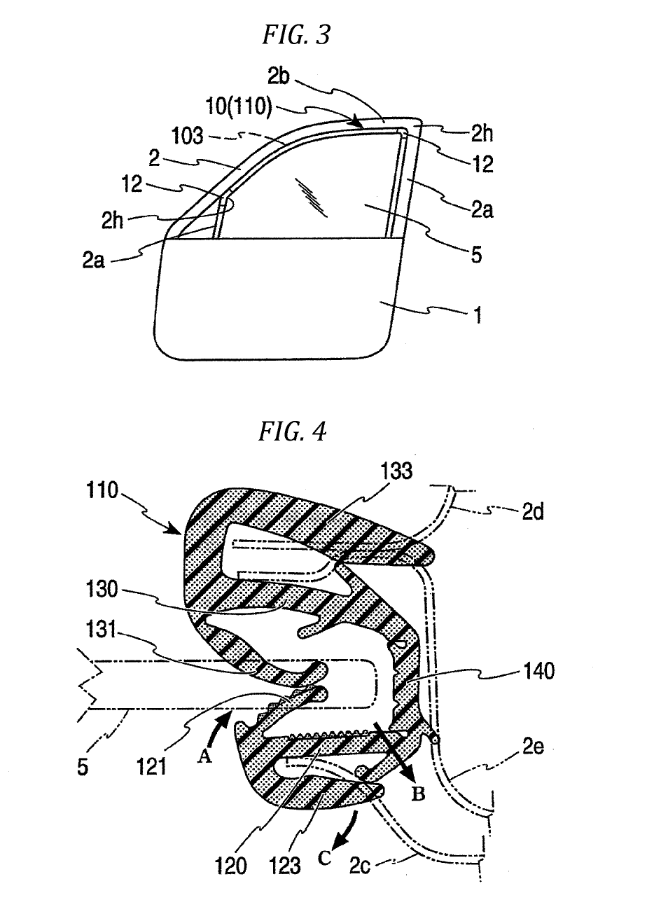

FIG. 3 is a front view of a front side door 1 of a motor vehicle, and FIG. 2 is a front view of a front side door glass run 10 which is attached to a door frame 2 of the front side door 1. As shown in FIG. 3, the door frame 2 is provide at an upper portion of the front side door 1, and a glass window 5 is mounted therein so as to be raised and lowered freely. Namely, the glass run 10 is attached to an inner circumference of the door frame 2 not only to guide a vertical movement of the glass window 5 but also to provide a seal between the glass window 5 and the door frame 2.

As shown in FIG. 2, the glass run 10 includes straight portions 11 which are extruded as a whole and corner portions 2h of the door frame 2 which are molded. The corner portions 12 are attached to corner portions 2h of the door frame 2 to connect the straight portions 11 together.

The straight portions 11 each include a glass run upper side portion 13 which is attached to an upper side portion 2b of the door frame 2, a glass run rear vertical side portion 15 which is attached to a rear vertical side portion 2a of the door frame 2, and a glass run front vertical side portion 14 which is attached to a division sash which constitutes a front vertical side portion 2a of the door frame 2.

The corner portions 12 are molded to connect the straight portions 11 together at the front and rear corner portions so that these extruded portions can follow a shape which matches that of the door frame 2. The corner portions 12 of the glass run 10 are mounted at the corner portions 2h of the door frame 2.

The door 1 and a body opening portion circumferential edge 6 are sealed together up by bringing weatherstrips (not shown) attached to outer circumferences of the door panel and the door frame 2 into abutment with the body opening portion circumferential edge 6, and the door frame 2 and the glass window 5 are sealed together by the glass run 10.

As shown in FIG. 1, at the vertical side portion 2a of the door frame 2 of the pressed door, the glass run 10 is attached to a door outer panel flange portion 2f and a door inner panel flange portion 2j which are distal ends of a door outer panel 2c and a door inner panel 2d, respectively.

The cross sectional shape of glass run rear vertical side portion 15 of the glass run 10 which is attached to the vertical side portion 2a of the door frame 2 has a substantially U-shaped cross section which is formed, as shown in FIG. 1, by a bottom wall 40, an outboard side wall 20 which extends downwards (downwards in FIG. 1) substantially at right angles or slightly at an obtuse angle to the bottom wall 40 from an outboard side edge portion of the bottom wall 40 and an inboard side wall 30 which extends downwards substantially at right angles or slightly at an obtuse angle to the bottom wall 40 from an inboard side edge portion of the bottom wall 40. As will be described later, the inboard side wall 30 is formed larger and thicker than the outboard side wall 20, so that the substantially U-shaped cross section has an asymmetrical shape in which an inboard side is larger than an outboard side thereof.

The outboard side wall 20, the inboard side wall 30 and the bottom wall 40 which constitute a main body of the glass run 10 basically have almost similar substantially U-shaped cross sections not only at portions to be attached to the upper side portion 2b but also at portions to be attached to the vertical side portion 2a of the door frame 2.

It is noted that in the aforesaid description, onboard and inboard denote an outside and an inside of a passenger compartment of the vehicle, respectively, with the door closed, and upper and lower denote an upward direction and a downward direction of the vehicle, respectively.

Firstly, the outboard side wall 20 will be described.

The outboard side wall 20 of the glass run rear vertical side portion 15 has a substantially plate-shaped cross section.

An outboard seal lip 21 is provided near a distal end of the outboard side wall 20 so as to extend therefrom into an inside of the substantially U-shaped cross section of the main body. The outboard side wall 20 is formed thinner and smaller than the inboard side wall 30.

The outboard seal lip 21 is provided on an inner side of the outboard side wall 20 so as to extend obliquely towards the inside of the substantially U-shaped cross section of the main body of the glass run 10.

When the glass window 5 is raised so that an upper end of the glass window 5 enters an interior of the glass run upper side portion 13 of the glass run 10, the outboard seal lip 21 and an inboard seal lip 31, which will be described later, are brought into elastic abutment with both surfaces of the upper end of the glass window 5 to seal a gap between the distal end of the glass window 5 and the door frame 2. A member having a low sliding resistance or projecting rib can be formed on a surface of the outboard seal lip 21 so as to reduce the sliding resistance against the glass window 5.

Additionally, an outboard cover lip 23 is provided on the outboard side wall 20 so as to extend from the distal end thereof towards an outside of the substantially U-shaped cross section, that is, so as to extend parallel to the outboard side wall 20 on an outboard side of the substantially U-shaped main body portion.

An outboard holding channel 27 is formed between the outboard side wall 20 and the outboard cover lip 23. The door outer panel flange portion 2f at the distal end of the door outer panel 2c is inserted into this outboard holding channel 27. Because of this, the door outer panel flange portion 2f at the distal end of the door outer panel 2c can be covered by the outboard cover lip 23, thereby providing a good external appearance.

An outboard holding projecting portion 24 whose rigidity is greater than those of other portions of the outboard side wall is formed from a side of the outboard side wall 20 which lies closer to the bottom wall 40 in the direction of the outboard holding channel 27. A distal end of the outboard holding projecting portion 24 is in abutment with a portion of the door outer panel 2c where a bent portion 2k is formed. As shown in FIG. 1, a gap is provided between a door reinforcement panel 2e with which the bottom wall 40 is brought into abutment and the door outer panel 2c.

When the outboard seal lip 21 is pulled in by the glass window 5 as a result of the glass window 5 being raised or lowered, whereby the outboard side wall 20 deflects in a direction in which the outboard side wall 20 is caused to slide in between the door outer panel 2c and the door reinforcement panel 2e, the outboard holding projecting portion 24 is brought into abutment with the door outer panel 2c and the bottom wall 40 is brought into abutment with the door reinforcement panel 2e in a resisting fashion, this preventing the outboard side wall 20 from entering the gap, whereby the deformation of the outboard side wall 20 can be prevented. This prevents a distal end of the outboard cover lip 23 from being pulled by the outboard seal lip 21 to move away from the door outer panel 2c.

When the glass window 5 enters the main body portion of the glass run 10 to be raised or lowered, the glass window 5 pulls the outboard seal lip 21 in a vertical direction to deform the outboard side wall 20. Although the outboard side wall 20 is caused to slide in greatly between the door outer panel 2c and the door reinforcement panel 2e as the outboard side wall 20 is deformed, since the outboard holding projecting portion 24 of the outboard side wall 20 is formed on the glass run rear vertical side portion 15 that is mounted on the vertical side portion of the door frame 2, the outboard holding projecting portion 24 can prevent particularly the glass run rear vertical side portion 15 from being caused to slide in. A holding projecting portion similar to the outboard holding projecting portion 24 can also be formed on the glass run upper side portion 13 and the glass run front vertical side portion 14.

The outboard holding projecting portion 24 has the greater rigidity than those of the other portions of the outboard side wall 20, and the outboard holding projecting portion 24 having the greater rigidity is formed thicker than the other portions of the outboard side wall 20 to thereby be allowed to have the greater rigidity. As this occurs, the outboard holding projecting portion 24 and the other portions of the outboard side wall 20 can be formed of the same material, which not only facilitates the formation of the outboard holding projecting portion 24 but also enhances the productivity of the glass run 10. Additionally, the material having large rigidity, for example, the material having large hardness can be used for the outboard holding projecting portion 24.

Since the door outer panel 2c is held by the outboard holding projecting portion 24 having the greater rigidity than those of the other portions of the outboard side wall 20 and the outboard cover lip 23, the door outer panel 2c can be held strongly and rigidly, whereby an outboard side of the glass run 10 can be attached to the door frame 2 strongly and rigidly.

An outboard auxiliary projecting portion 25 can be formed on an external surface of the outboard side wall 20 in a position which lies closer to an opening side of the main body of the glass run 10 than a position where the outboard holding projecting portion 24 is formed so as to extend therefrom in the direction of the outboard holding channel 27. As this occurs, when the glass window 5 enters the main body portion of the glass run 10 to push the outboard seal lip 21 whereby the outboard seal lip 21 is brought into abutment with the outboard side wall 20, the outboard auxiliary projecting portion 25 is brought into abutment with the door outer panel 2c to thereby prevent the deformation of the outboard side wall 20, thereby making it possible to prevent the distal end of the outboard cover lip 23 from moving away from the door outer panel 2c.

Outboard projecting portions 28 can be formed on a portion of an internal surface of the outboard side wall 20 with which the outboard seal lip 21 is brought into abutment. When the glass window 5 enters the interior of the main body of the glass run 10 for the outboard seal lip 21 to be pressed against the internal surface of the outboard side wall 20, the outboard projecting portions 28 can prevent the outboard seal lip 21 from being brought into close contact with the internal surface of the outboard side wall 20.

Next, the inboard side wall 30 will be described.

The inboard side wall 30 is formed thicker in thickness and greater in size than the outboard side wall 20. This enables the glass run 10 to be held to a side surface of the door frame 2.

An inboard cover lip 33 is formed at a distal end of the outboard side wall 30 so as to extend therefrom to face an external surface of the inboard side wall 30 or the substantially U-shaped cross section of the main body. Because of this, a door inner panel flange portion 2j at a distal end of the door inner panel 2d and a door reinforcement panel flange portion 2g at a distal end of the door reinforcement panel 2e can be covered by the inboard cover lip 33, thereby providing a good external appearance.

An inboard holding channel 37 is formed between the inboard side wall 30 and the inboard cover lip 33. The door inner panel flange portion 2j and the door reinforcement panel flange portion 2g are inserted into the inboard holding channel 37 so as to be held in place therein. As shown in FIG. 1, a distal end of the door reinforcement panel flange portion 2g is bent slightly in an outboard direction so as to form a bent portion 2m.

An inboard holding lip 34 is formed on the external surface of the inboard side wall 30 in a position which corresponds to a distal end of the inboard cover lip 33. Root portions of the door inner panel flange portion 2j and the door reinforcement panel flange portion 2g are held by the inboard holding lip 34 and the inboard cover lip 33, and the inboard holding lip 34 is locked at the bent portion 2m of the door reinforcement panel flange portion 2g. This allows a side of the glass run 10 which faces the inboard side wall 30 to be held by the door inner panel 2d and the door reinforcement panel 2e.

An inboard seal lip 31 is provided at the distal end of the inboard side wall 30 so as to extend therefrom obliquely into the interior of the substantially U-shaped cross section of the main body of the glass run 10. Since the inboard seal lip 31 is formed longer and thicker than the outboard seal lip 21, when the glass window 5 enters the interior of the glass run 10, the glass window 5 can be positioned outboards to thereby reduce a difference in level between the door frame 2 and the glass window 5. This reduces air resistance and wind noise and is preferable in terms of design of the external appearance.

An inboard locking lip 35 is formed on an internal surface of the inboard side wall 30 at a portion with which a distal end of the inboard seal lip 31 is brought into abutment. When the glass window 5 enters the interior of the main body of the glass run 10 to press the inboard seal lip 31 against the internal surface of the inboard side wall 30, the inboard seal lip 31 can be prevented from being brought into close contact with an internal surface of the outboard side wall 20.

The bottom wall 40 has a substantially plate-like shape, and bottom wall channel portions 42 are formed on a continuous portion which connects the inboard side wall 30 to the outboard side wall 20 so that the bottom wall 40 can easily be bent at the continuous portion. Bottom wall holding lips 41, 41 are formed on an internal surface of the bottom wall 40 so as to lie adjacent to the corresponding bottom wall channel portions 42. The bottom wall holding lips 41, 41 are in abutment with portions of the outboard side wall 20 and the inboard side wall 30 which lie near the roots thereof so as to prevent the outboard side wall 20 and the inboard side wall 30 from collapsing in the direction of the interior of the substantially U-shaped cross section.

A plurality of grooves which continue in a longitudinal direction are formed on a bottom wall abutment surface 43 on an internal surface of the bottom wall 40 so as to prevent the distal end of the glass window 5 from being brought into close contact with the bottom wall abutment surface 43. Additionally, a low sliding resistance layer can also be formed on the bottom wall abutment surface 43. As this occurs, even though the distal end of the glass window 5 is brought into abutment with the bottom wall abutment surface 43, the glass window 5 can be raised or lowered smoothly.

Then, as shown in FIGS. 1 and 2, the door reinforcement panel 2e is attached to part of the vertical side portion 2a of the door frame 2. When the glass run rear vertical side portion 15 is mounted on the vertical side portion 2a, the bottom wall 40 of the glass run 10 is held by the door reinforcement panel 2e at the portion where the door reinforcement panel 2e is attached. Thus, even though the glass window 5 is raised or lowered to press against the bottom wall 40, the outboard side wall 20 and the bottom wall 40 are never be pushed largely into the door frame 2.

The bottom wall holding lips 41 can be provided on an external surface of the bottom wall 40. The bottom wall holding lips 41 are brought into abutment with the door reinforcement panel 2e to hold the bottom wall 40 and mitigate an impact produced when the distal end of the glass window 5 is brought into abutment with the bottom wall abutment surface 43 while providing a seal between the bottom wall 40 and the door reinforcement panel 2e.

In forming the straight portions 11 of the glass run 10, a synthetic rubber or a thermally plastic elastomer is used as a material. For example, an EPDM rubber is used as a synthetic rubber material, and an elastomer of a polyolefin elastomer system is used as a thermally plastic elastomer.

In the case of a synthetic rubber, extruded straight portions are transferred to a vulcanizing tank to be vulcanized by heating with hot air or high-frequency wave. In the case of a thermally plastic elastomer, extruded straight portions are cooled to be solidified. Thereafter, the extruded straight portions are cut to predetermined lengths for fabrication.

Next, in forming molded portions for the corner portions 12 of the glass run 10, the extruded member fabricated in the way described above is cut to the predetermined lengths substantially at right angles to a longitudinal direction of the extruded member. Then, end portions of the extruded portion which is so cut are held in molds to mold molded portions, and a solid material from which molded portions are molded is injected into cavities of the molds. A cross-sectional shape of the molded portion is substantially the same as a cross-sectional shape of the extruded portion. A similar kind of material to the material used to extrude the extruded portion is preferably used as a material to mold the molded portions. In the case of a thermally plastic elastomer being used, since a thermally plastic elastomer material is molten when it is injected into the molds, the extruded portion and portions to be molded are integrally fused together by heat and pressure.

In the case of the straight portions 11 of the glass run 10 being formed from an EPDM rubber, the corner portions 12 of the glass run 10 are preferably formed from an EPDM rubber or an olefin based thermally plastic elastomer. In the case of the straight portions 11 of the glass run 10 being formed from the olefin based thermally plastic elastomer, the corner portions 12 of the glass run 10 are preferably formed from the olefin based thermally plastic elastomer. In this case, the materials of the same kind are used, and hence, the straight portion 11 and the corner portions 12 of the glass run 10 can be bonded together well. Additionally, the straight portions 11 and the corner portions 12 are formed from the olefin based materials, and hence, it is possible to obtain products which can easily recycle which provide good weathering and which can be ground together. In the case of the olefin based thermally plastic elastomers being used to fabricate the straight portions 11 and the corner portions 12 of the glass run 10, since no vulcanization is necessary, the fabrication can be facilitated.

In the case of a synthetic rubber being used to fabricate the corner portions 12 of the glass run 10, the synthetic rubber is injected into the molds and thereafter is vulcanized by heating the molds. As this occurs, since the same material or materials of the same kind are used to fabricate the extruded portions and the molded portions, they can be vulcanization bonded together to be integrally sealed together.

What is claimed is:

1. A glass run for a motor vehicle, which is attached to an inner circumference of a door frame of a motor vehicle door to guide a vertical movement of a glass window, comprising:
a glass run main body, having a substantially U-shaped cross section, including a bottom wall, an outboard side wall which extends from an outboard side edge portion of the bottom wall and an inboard side wall which extends from an inboard side edge portion of the bottom wall;
an outboard seal lip and an inboard seal lip, which extend towards an inside of the substantially U-shaped cross section of the main body, provided on the outboard side wall and the inboard side wall, respectively, to seal an outboard surface and an inboard surface of the glass window by the outboard seal lip and the inboard seal lip, respectively;
an outboard cover lip formed from a distal end of the outboard side wall so as to face an external surface of the substantially U-shaped cross section; and
an inboard cover lip formed from a distal end of the inboard side wall so as to face an external surface of the substantially U-shaped cross section, wherein:
a flange portion at a distal end of a door outer panel of the door frame is held in an outboard holding channel formed between the outboard side wall and the outboard cover lip;
a flange portion at a distal end of a door inner panel of the door frame is held in an inboard holding channel formed between the inboard side wall and the inboard cover lip;
the bottom wall is held by a door reinforcement panel of the door frame;
an outboard holding projecting portion, whose rigidity is greater than those of other portions of the outboard side wall, is formed from the outboard side wall in the direction of the outboard holding channel; and
one end of the outboard holding projecting portion is brought into abutment with the outer panel.

2. The glass run according to claim 1, further comprising
an outboard auxiliary projecting portion formed on the outboard side wall in a position lying closer to an opening side of the glass run main body than a portion where the outboard holding projecting portion is formed in the direction of the outboard holding channel.

3. The glass run according to claim 1, wherein
the outboard holding projecting portion of the outboard side wall is formed on a glass run vertical side portion which is mounted on a vertical side portion of the door frame.

4. The glass run according to claim 1, wherein
the outboard holding projecting portion whose rigidity is greater than those of the other portions of the outboard side wall is formed thicker than the other portions of the outboard side wall.

5. The glass run according to claim 1, wherein
the door outer panel is held by the outboard holding projecting portion whose rigidity is greater than those of the other portions of the outboard side wall and the outboard cover lip.
